(19) United States
(12) Patent Application Publication
(10) Pub. No.: US 2024/0399877 A1
(43) Pub. Date: Dec. 5, 2024

(54) VARIABLE REGENERATION CONTROL FOR ELECTRIFIED VEHICLE WITH FIRST SURFACE INTERFACE

(71) Applicant: FCA US LLC, Auburn Hills, MI (US)

(72) Inventors: Richard S Silbert, Bingham Farms, MI (US); Eric Mozer, Cement City, MI (US); Patrick Reed, Washington, MI (US); Jason Vincent, Howell, MI (US)

(21) Appl. No.: 18/326,491

(22) Filed: May 31, 2023

(51) Int. Cl. B60L 7/18; B60K 37/06

(52) U.S. Cl. CPC B60L 7/18; B60K 35/10

(57) ABSTRACT

Regeneration control techniques for an electrified vehicle include a regeneration control device arranged on a first surface in the electrified vehicle such that it is accessible to a driver of the electrified vehicle, the regeneration control device being configured to control a selected regeneration level for the electrified vehicle from a plurality of different regeneration levels and a controller configured to control a regeneration system of the electrified vehicle based on the selected regeneration level, wherein the regeneration system includes at least one of a regenerative braking system of the electrified vehicle and a torque generator/consumer mode of an electric motor of the electrified vehicle, and wherein the regeneration control device provides the driver with the ability to perform faster adjustments to a degree of regeneration by the regeneration system during operation of the electrified vehicle.

### FIELD

The present application generally relates to electrified vehicles and, more particularly, to techniques for variable regeneration control in electrified vehicles with a first surface interface.

### BACKGROUND

Electrified vehicles have an electrified powertrain including one or more electric motors powered by a high voltage battery system and configured to generate propulsive drive torque. Regeneration in an electrified vehicle refers to the conversion of the vehicle's kinetic energy into electrical energy for recharging its battery system(s). This could include for example, any combination of regenerative braking and operating the electric motor(s) as generators (torque consumers). Every driver has their own preference as to how much regeneration provides an acceptable deceleration feel of the electrified vehicle. As such, some electrified vehicles provide controls for varying the degree of regeneration. These conventional regeneration control features are typically buried within multiple layers of menus of an infotainment unit, and thus are difficult for the driver to find and, more particularly, to adjust on-the-fly during driving. Accordingly, while such conventional electrified vehicle regeneration control systems do work well for their intended purpose, there exists an opportunity for improvement in the relevant art.

### SUMMARY

According to one example aspect of the invention, a regeneration control system for an electrified vehicle is presented. In one exemplary implementation, the regeneration control system comprises a regeneration control device arranged on a first surface in the electrified vehicle such that it is accessible to a driver of the electrified vehicle, the regeneration control device being configured to control a selected regeneration level for the electrified vehicle from a plurality of different regeneration levels and a controller in communication with the regeneration control device and configured to receive the selected regeneration level from the regeneration control device, and control a regeneration system of the electrified vehicle based on the selected regeneration level, wherein the regeneration system includes at least one of a regenerative braking system of the electrified vehicle and a torque generator/consumer mode of an electric motor of the electrified vehicle, wherein the regeneration control device provides the driver with the ability to perform faster adjustments to a degree of regeneration by the regeneration system during operation of the electrified vehicle.

In some implementations, the regeneration control device is arranged on a dash of the electrified vehicle proximate to an ignition/start button of the electrified vehicle. In some implementations, the regeneration control device is connected to a local interconnect network (LIN) bus of the electrified vehicle proximate to an ignition module associated with the ignition/start button. In some implementations, the regeneration control device is a rotary knob. In some implementations, the regeneration control device is a slider device.

In some implementations, the regeneration control device is not part of or otherwise associated with an infotainment unit of the electrified vehicle. In some implementations, the regeneration control device is easily controllable by the driver of the vehicle without the driver taking his/her eyes off of a road along which the vehicle is traveling. In some implementations, the plurality of different control levels include a number of levels that provide a sufficient degree of selectability while also being distinguishable by the driver via electrified vehicle feedback. In some implementations, the plurality of different control levels includes ten different control levels.

According to another example aspect of the invention, a regeneration control method for an electrified vehicle is presented. In one exemplary implementation, the method comprises providing a regeneration control device arranged on a first surface in the electrified vehicle such that it is accessible to a driver of the electrified vehicle, the regeneration control device being configured to control a selected regeneration level for the electrified vehicle from a plurality of different regeneration levels, providing a controller in communication with the regeneration control device, receiving, by the controller, the selected regeneration level from the regeneration control device, and controlling, by the controller, a regeneration system of the electrified vehicle based on the selected regeneration level, wherein the regeneration system includes at least one of a regenerative braking system of the electrified vehicle and a torque generator/consumer mode of an electric motor of the electrified vehicle, wherein the regeneration control device provides the driver with the ability to perform faster adjustments to a degree of regeneration by the regeneration system during operation of the electrified vehicle.

In some implementations, the regeneration control device is arranged on a dash of the electrified vehicle proximate to an ignition/start button of the electrified vehicle. In some implementations, the regeneration control device is connected to a LIN bus of the electrified vehicle proximate to an ignition module associated with the ignition/start button. In some implementations, the regeneration control device is a rotary knob. In some implementations, the regeneration control device is a slider device.

In some implementations, the regeneration control device is not part of or otherwise associated with an infotainment unit of the electrified vehicle. In some implementations, the regeneration control device is easily controllable by the driver of the vehicle without the driver taking his/her eyes off of a road along which the vehicle is traveling. In some implementations, the plurality of different control levels include a number of levels that provide a sufficient degree of selectability while also being distinguishable by the driver via electrified vehicle feedback. In some implementations, the plurality of different control levels includes ten different control levels.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a regeneration control system with a first surface interface according to the principles of the present application;

FIG. 2 is a partial view of an example dash of an electrified vehicle including an example regeneration control device in an example position according to the principles of the present application; and

FIG. 3 is a flow diagram of an example regeneration control method for an electrified vehicle with a first surface interface according to the principles of the present application.

### DESCRIPTION

As previously discussed, some electrified vehicles provide controls for varying the degree of regeneration. These conventional regeneration control features are typically buried multiple layers into menus of an infotainment unit, and thus are difficult for the driver to find and, more particularly, to adjust on-the-fly during driving. Accordingly, improved techniques that provide regeneration control in an electrified vehicle with a first surface interface are presented herein. The term “first surface interface” refers to the control feature or mechanism being immediately apparent and controllable by the driver. One primary proposed mechanism is a rotary knob (or alternatively, a slider device) located near the ignition/start button of the electrified vehicle. This particular location is both easy for the driver to access during driving (e.g., without taking his/her eyes off the road) and also is easily integrated into the local interconnect network (LIN) bus that is already running to the nearby ignition module. This allows the driver to continuously adjust the degree of regeneration based on the deceleration feel as feedback, as well as intentionally adjust regeneration (e.g., more aggressively) during specific operation such as trailering.

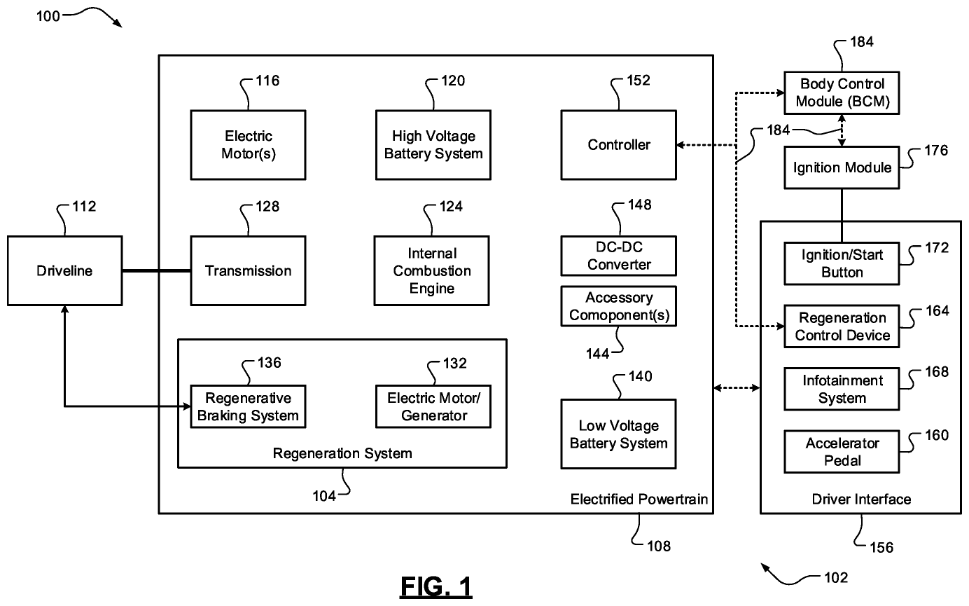

Referring now to FIG. 1, a functional block diagram of an electrified vehicle 100 having a regeneration control system 102 with a first surface interface according to the principles of the present application is illustrated. The electrified vehicle 100 includes an electrified powertrain 108 configured to generate and transfer drive torque to a driveline 112 for propulsion. A regeneration system 104 is configured to convert kinetic energy at the driveline 112 or the electrified powertrain 108 into electrical energy as more fully described below. The electrified powertrain 108 includes one or more electric motors 116 (e.g., electric traction motors) powered by a high voltage battery system 120. The electrified powertrain 108 optionally includes an internal combustion engine 124 configured to combust a mixture of air and fuel (diesel, gasoline, etc.) to generate drive torque for vehicle propulsion and/or for generation of electrical energy via the regeneration system. A transmission 128 (e.g., a multi-speed automatic transmission) is configured to transfer the drive torque to the driveline 112.

As shown, the regeneration system 104 includes an electric motor/generator 132 and a regenerative braking system 136. The electric motor/generator 132 is configured to generate alternating current (AC) that is converted by an AC to direct current (DC) converter (not shown) for battery system recharging. The electric motor/generator 132 could be a separate electric motor device associated with the optional engine 124 and/or one of the electric motor(s) 116. The regenerative braking system 136 is configured to convert kinetic energy from braking at the driveline 112 into electrical energy (DC) for battery system recharging. The electrified vehicle 100 further comprises a low voltage battery system 140 configured to power low voltage accessory components 144 of the electrified vehicle 100 and a DC-DC converter 148 for stepping up/down voltages in the electrified vehicle 100. For example only, the higher DC voltage output by the high voltage battery system 120 could be stepped down to a lower DC voltage for recharging the low voltage battery system 140, or vice-versa (e.g., stepped up). While only two example components of the regeneration system 104 are illustrated, it will be appreciated that the regeneration system 104 could include any suitable regeneration components.

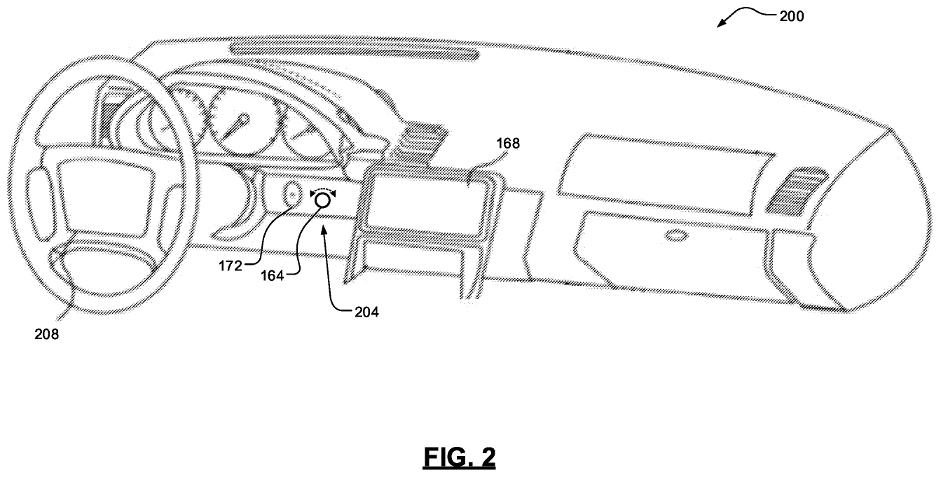

The electrified vehicle 100 further includes a controller 152 configured to control the electrified vehicle 100 and, more particularly, the electrified powertrain 108. For example, the controller 152 controls the electrified powertrain 108 to satisfy a driver torque request provided by a driver via an accelerator pedal 160 of a driver interface 156. The control of the electrified powertrain 108 also includes control of the regeneration system 104 based on a selected regeneration level provided by the driver via a regeneration control device 164 of the driver interface 156. The regeneration control device 164 is a first surface device, meaning that it is directly accessible/controllable by the driver (i.e., without searching through sub-menus of an infotainment unit or system 168 of the driver interface 156). Non-limiting examples of the regeneration control device 164 include a rotary knob and a slider device. In one exemplary implementation, the regeneration control device 164 is arranged proximate to an ignition/start button 172 of the driver interface 156, which is connected to an ignition module 176 that is in communication via a LIN bus 180 with a body control module (BCM) 184 and the controller 152 as shown in FIG. 2 and as described more fully below.

Referring now to FIG. 2 and with continued reference to FIG. 1, a partial view of an example dash 200 of an electrified vehicle including an example regeneration control device 164 in an example position 204 according to the principles of the present application is illustrated. While the electrified vehicle 100 and its components are referenced for illustrative/descriptive purposes, it will be appreciated that the example dash 200 could be applicable to any suitable electrified vehicle. It will be appreciated that this is also merely a partial view of the example dash 200 of the electrified vehicle 100 and the dash 200 could have other suitable configurations/layouts and other non-referenced (e.g., a dash cluster) or non-illustrated components. As shown, the regeneration control device 164 is a rotary knob that is adjustable between ten different regeneration levels (e.g., 0% MIN to 100% MAX in 10% intervals). It will be appreciated that the regeneration control device 164 could also have another suitable configuration (e.g., a slider-type device) and that any number of levels that provide a sufficient degree of selectability while also being distinguishable by the driver via electrified vehicle feedback could be utilized.

The regeneration control device 164 is arranged on the dash 200 in the example position 204 that is proximate to an example of the ignition/start button 172. This example position 204 provides the driver with the ability to perform faster adjustments to a degree of regeneration by the regeneration system 104 during operation of the electrified vehicle 100. The regeneration control device 164 is a first surface device (i.e., not associated with menus/sub-menus of an example of the infotainment system 168). This example position 204 also does not have any other devices/switches that are typically controlled by the driver during operation of the electrified vehicle 100 and thus makes it easy for the driver to control/manipulate, such as without taking his/her hands off of a steering wheel 208. In addition, the ignition/start button 172 is connected to the ignition module 176 (not shown as it is behind the surface of the dash 200), which is in turn connected to the controller 152 via the LIN bus 180 (e.g., via BCM 184). This allows for the regeneration control device 164 to be easily connected to the LIN bus 180 and thereby integrated into the existing network for communication with the controller 152.

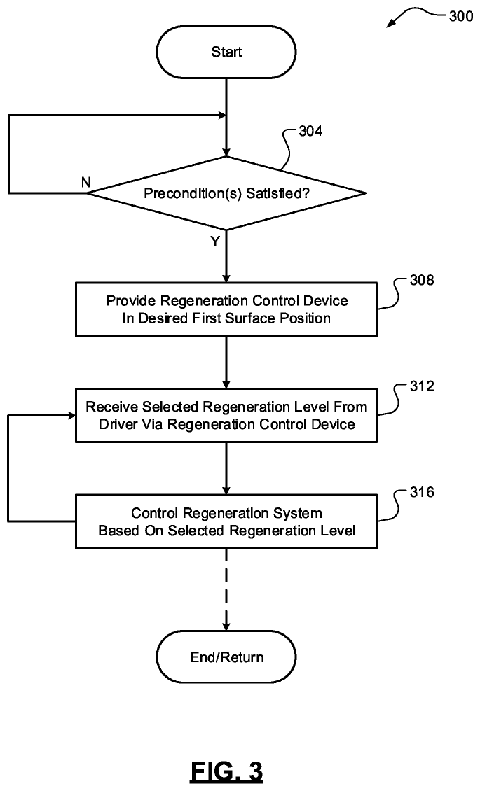

Referring now to FIG. 3 and with continued reference to FIGS. 1-2, a flow diagram of an example regeneration control method 300 for an electrified vehicle with a first surface interface according to the principles of the present application is illustrated. While the electrified vehicle 100 and its components are specifically referenced for illustrative/descriptive purposes, it will be appreciated that the method 300 could be applicable to any suitable electrified vehicle (xEV). At 304, the controller 152 determines whether a set of one or more precondition(s) are satisfied. This could include, for example only, the electrified vehicle 100 being powered up and running and there being no malfunctions or faults present that would otherwise affect the regeneration system 104 or any aspects of the method 300. When false, the method 300 ends or returns to 304. Otherwise, the method 300 continues to 308. At 308, the regeneration control device 164 is provided at a desired first surface location, such as the example position 204 of FIG. 2 (proximate to the ignition/start button 172). At 312, the controller 152 receives a driver-selected regeneration level from the driver via the regeneration control device 164. As previously mentioned, this could be one of a plurality of predefined regeneration levels, such as from ten levels (e.g., 0% to 100% in 10% intervals). At 316, the controller 152 controls the regeneration system 104 based on the selected regeneration level. This could be in conjunction with controlling the amount of drive torque being generated by the electrified powertrain 108 to satisfy the driver torque request (e.g., via the accelerator pedal), including accounting for negative torque or torque being consumed by the regeneration system 104. The method 300 could then return to 312 where further tuning/adjustment by the driver of the selected regeneration level could occur until an end of a current drive cycle. The method 300 could alternatively end or return to 304.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A regeneration control system for an electrified vehicle, the regeneration control system comprising:
a regeneration control device arranged on a first surface in the electrified vehicle such that it is directly accessible to a driver of the electrified vehicle, the regeneration control device being configured to control a selected regeneration level for the electrified vehicle from a plurality of different regeneration levels; and
a controller in communication with the regeneration control device and configured to:
receive the selected regeneration level from the regeneration control device; and
control a regeneration system of the electrified vehicle based on the selected regeneration level, wherein the regeneration system includes at least one of a regenerative braking system of the electrified vehicle and a torque generator/consumer mode of an electric motor of the electrified vehicle,
wherein the regeneration control device provides the driver with an ability to perform faster adjustments to a degree of regeneration by the regeneration system during operation of the electrified vehicle.

2. The regeneration control system of claim 1, wherein the regeneration control device is arranged on a dash of the electrified vehicle proximate to an ignition/start button of the electrified vehicle.

3. The regeneration control system of claim 2, wherein the regeneration control device is connected to a local interconnect network (LIN) bus of the electrified vehicle proximate to an ignition module associated with the ignition/start button.

4. The regeneration control system of claim 1, wherein the regeneration control device is a rotary knob.

5. The regeneration control system of claim 1, wherein the regeneration control device is a slider device.

6. The regeneration control system of claim 1, wherein the regeneration control device is not part of or otherwise associated with an infotainment unit of the electrified vehicle.

7. The regeneration control system of claim 1, wherein the regeneration control device is easily controllable by the driver of the vehicle without the driver taking his/her eyes off of a road along which the vehicle is traveling.

8. The regeneration control system of claim 1, wherein the plurality of different control levels include a number of levels that provide a sufficient degree of selectability while also being distinguishable by the driver via electrified vehicle feedback.

9. The regeneration control system of claim 8, wherein the plurality of different control levels includes ten different control levels.

10. A regeneration control method for an electrified vehicle, the method comprising:
providing a regeneration control device arranged on a first surface in the electrified vehicle such that it is accessible to a driver of the electrified vehicle, the regeneration control device being configured to control a selected regeneration level for the electrified vehicle from a plurality of different regeneration levels;
providing a controller in communication with the regeneration control device;
receiving, by the controller, the selected regeneration level from the regeneration control device; and
controlling, by the controller, a regeneration system of the electrified vehicle based on the selected regeneration level, wherein the regeneration system includes at least one of a regenerative braking system of the electrified vehicle and a torque generator/consumer mode of an electric motor of the electrified vehicle,
wherein the regeneration control device provides the driver with the ability to perform faster adjustments to a degree of regeneration by the regeneration system during operation of the electrified vehicle.

11. The method of claim 10, wherein the regeneration control device is arranged on a dash of the electrified vehicle proximate to an ignition/start button of the electrified vehicle.

12. The method of claim 11, wherein the regeneration control device is connected to a local interconnect network (LIN) bus of the electrified vehicle proximate to an ignition module associated with the ignition/start button.

13. The method of claim 10, wherein the regeneration control device is a rotary knob.

14. The method of claim 10, wherein the regeneration control device is a slider device.

15. The method of claim 10, wherein the regeneration control device is not part of or otherwise associated with an infotainment unit of the electrified vehicle.

16. The method of claim 10, wherein the regeneration control device is easily controllable by the driver of the vehicle without the driver taking his/her eyes off of a road along which the vehicle is traveling.

17. The method of claim 10, wherein the plurality of different control levels include a number of levels that provide a sufficient degree of selectability while also being distinguishable by the driver via electrified vehicle feedback.

18. The method of claim 17, wherein the plurality of different control levels includes ten different control levels.
